(19) United States
(12) Patent Application Publication
(10) Pub. No.: US 2025/0083713 A1
(43) Pub. Date: Mar. 13, 2025

(54) RAILCARS FOR TRANSPORTING GRANULATED METALLIC UNITS, AND ASSOCIATED SYSTEMS, DEVICES, AND METHODS

(71) Applicant: SUNCOKE TECHNOLOGY AND DEVELOPMENT LLC, Lisle, IL (US)

(72) Inventors: John Francis QUANCI, Haddonfield, NJ (US); John Michael RICHARDSON, Devon, PA (US); Patrick James MULLARKEY, Manhattan, IL (US); David James SCHWAKE, Aurora, IL (US); Andrew Michael BUTOR, Cranberry Township, PA (US); Jonathan Hale PERKINS, Lisle, IL (US); Chun Wai CHOI, Lisle, IL (US)

(21) Appl. No.: 18/882,116

(22) Filed: Sep. 11, 2024

Related U.S. Application Data
(60) Provisional application No. 63/581,946, filed on Sep. 11, 2023.

(51) Int. Cl. B61D 17/18; B61D 7/02; B61D 7/32

(52) U.S. Cl. CPC B61D 17/18; B61D 7/02; B61D 7/32

(57) ABSTRACT

Railcars for transporting granulated metallic units, and associated systems, devices, and methods are disclosed herein. For example, a reinforced railcar apparatus includes a container envelope and a reinforcement liner. The container envelope includes side walls and end walls extending from a floor of the railcar. The side walls are a first length and the end walls are a second length less than the first length. Top portions of the rigid side walls and end walls define an opening of the container envelope through which granulated metallic units are discharged into the railcar assembly. The railcar assembly includes angled interior walls coupled to the bottom surface and extending from a top portion of the end walls to the bottom surface. The reinforcement liner is disposed over a portion of the bottom surface and the angled interior walls. In some embodiments, the railcar assembly includes an open-topped box layered with impact-absorbing material.

### CROSS-REFERENCE TO RELATED APPLICATIONS

The present application claims the benefit of U.S. Provisional Patent Application No. 63/581,946, filed Sep. 11, 2023, and titled “SYSTEM AND METHOD FOR CONTINUOUS GRANULATED PIG IRON (GPI) PRODUCTION,” the disclosure of which is incorporated herein by reference in its entirety. The present application is related to the following applications, the disclosures of which are incorporated herein by reference in their entireties: U.S. patent application Ser. No. 18/882,045 [Attorney Docket No. 084553.8073.US00], filed Sep. 11, 2024, and titled “LOADING GRANULATED METALLIC UNITS INTO RAILCARS, AND ASSOCIATED SYSTEMS, DEVICES, AND METHODS”; U.S. patent application Ser. No. 18/882,191 [Attorney Docket No. 084553.8074.US00], filed Sep. 11, 2024, and titled “LOW-SULFUR GRANULATED METALLIC UNITS, AND ASSOCIATED SYSTEMS, DEVICES, AND METHODS”; U.S. patent application Ser. No. 18/882,638 [Attorney Docket No. 084553.8075.US00], filed Sep. 11, 2024, and titled “CONTINUOUS GRANULATED METALLIC UNITS PRODUCTION, AND ASSOCIATED SYSTEMS, DEVICES, AND METHODS”; U.S. patent application Ser. No. 18/882,661 [Attorney Docket No. 084553.8076.US00], filed Sep. 11, 2024, and titled “USE OF A BASIC OXYGEN FURNACE TO PRODUCE GRANULATED METALLIC UNITS, AND ASSOCIATED SYSTEMS, DEVICES, AND METHODS”; U.S. patent application Ser. No. 18/882,256 [Attorney Docket No. 084553.8077.US00], filed Sep. 11, 2024, and titled “LOW-CARBON GRANULATED METALLIC UNITS, AND ASSOCIATED SYSTEMS, DEVICES, AND METHODS”; U.S. patent application Ser. No. 18/882,531 [Attorney Docket No. 084553.8078.US00], filed Sep. 11, 2024, and titled “TORPEDO CARS FOR USE WITH GRANULATED METALLIC UNIT PRODUCTION, AND ASSOCIATED SYSTEMS, DEVICES, AND METHODS”; U.S. patent application Ser. No. 18/882,384 [Attorney Docket No. 084553.8079.US00], filed Sep. 11, 2024, and titled “TREATING COOLING WATER IN IRON PRODUCTION FACILITIES, AND ASSOCIATED SYSTEMS, DEVICES, AND METHODS”; U.S. patent application Ser. No. 18/882,465 [Attorney Docket No. 084553.8080.US00], filed Sep. 11, 2024, and titled “USE OF RESIDUAL IRON WITHIN GRANULATED METALLIC UNIT PRODUCTION FACILITIES, AND ASSOCIATED SYSTEMS, DEVICES, AND METHODS”; U.S. patent application Ser. No. 18/882,501 [Attorney Docket No. 084553.8081.US00], filed Sep. 11, 2024, and titled “PROCESSING GRANULATED METALLIC UNITS WITHIN ELECTRIC ARC FURNACES, AND ASSOCIATED SYSTEMS AND METHODS”.

### TECHNICAL FIELD

This present technology relates to railcars for transporting granulated metallic units, and associated systems, devices, and methods.

### BACKGROUND

Granulated pig iron (GPI) is a form of pig iron that is granulated into small, uniform particles, making it easier to handle, transport, and use in different metallurgical processes compared to conventional pig iron. The demand for GPI has been steadily increasing due to its versatile applications in various industries, including automotive, construction, and manufacturing. The growing popularity of GPI can be attributed to its high purity, consistent quality, and the efficiency it brings to the production of steel and other iron-based products.

Granulated pig iron is produced by rapidly cooling molten pig iron with water, resulting in the formation of granules. This process, known as granulation, is typically carried out after processing in blast furnaces. However, current production methods are often characterized by intermittent production cycles due to various operational constraints, such as the need for periodic maintenance, fluctuations in raw material supply, and energy consumption issues. These interruptions not only affect the overall efficiency but also lead to increased production costs and variability in product quality. Therefore, there is a need for an improved production process that can ensure continuous and stable granulation of pig iron, thereby enhancing productivity and reducing operational costs.

### BRIEF DESCRIPTION OF THE DRAWINGS

Features, aspects, and advantages of the presently disclosed technology may be better understood with regard to the following drawings.

FIG. 1 is a schematic block diagram of a continuous granulated metallic unit (GMU) production system configured in accordance with embodiments of the present technology.

FIG. 2 is a plan view of the continuous GMU production system of FIG. 1, configured in accordance with embodiments of the present technology.

FIG. 3 is an enlarged view of the continuous GMU production system of FIG. 2.

FIG. 4 is a schematic illustration of a system for loading GMUs into a railcar, configured in accordance with embodiments of the present technology.

FIG. 5 is a partially schematic perspective view of a railcar, configured in accordance with embodiments of the present technology.

FIG. 6 is a partially schematic cross-sectional view of the railcar of FIG. 5 at line A-A in accordance with embodiments of the present technology.

FIG. 7 is a partially schematic cross-sectional view of the railcar of FIG. 5 at line A-A in accordance with additional embodiments of the present technology.

FIG. 8 is a partially schematic cross-sectional view of the railcar of FIG. 5 at line A-A in accordance with additional embodiments of the present technology.

FIG. 9 is a partially schematic cross-sectional view of the railcar of FIG. 5 at line A-A in accordance with additional embodiments of the present technology.

FIG. 10 is a partially schematic cross-sectional view of the railcar of FIG. 5 at line A-A in accordance with additional embodiments of the present technology.

FIG. 11 is a partially schematic cross-sectional view of the railcar of FIG. 5 at line A-A in accordance with additional embodiments of the present technology.

FIG. 12 is a partially schematic side view of a mechanism for coupling reinforcement material to a railcar, configured in accordance with embodiments of the present technology.

FIG. 13 is a partially schematic side view of a mechanism for coupling reinforcement material to a railcar, configured in accordance with additional embodiments of the present technology.

FIG. 14A is a partially schematic side view of a mechanism for coupling reinforcement material to a railcar, configured in accordance with additional embodiments of the present technology.

FIG. 14B is a partially schematic front view of the mechanism of FIG. 14A.

FIG. 15A is a partially schematic side view of a mechanism for coupling a reinforcement material to a railcar, configured in accordance with additional embodiments of the present technology.

FIG. 15B is a partially schematic front view of the mechanism of FIG. 15A.

FIG. 15C is a partially schematic top view of the mechanism of FIG. 15A.

FIG. 16 is a flowchart illustrating a method of loading GMU into a reinforced railcar, configured in accordance with embodiments of the present technology.

A person skilled in the relevant art will understand that the features shown in the drawings are for purposes of illustrations, and variations, including different and/or additional features and arrangements thereof, are possible.

### DETAILED DESCRIPTION

### I. Overview

The present technology is generally directed to railcars for transporting granulated metallic units (GMUs), and associated systems, devices, and methods. The GMUs (i.e., a plurality of particles) can be a low carbon granulated iron (GI) and/or GPI. Conventional technology for loading various industrial products (e.g., GPI) into railcars typically involves discharging the product from a significant height into the container compartment of a railcar. Due to the relatively high-density and heavy granulated industrial products and substantial drop of these products, such loading forcefully impacts the interior surfaces of the railcar and can lead to rapid wear and erosion of the interior surfaces of the railcar. This not only compromises the railcar's structural integrity, but also increases maintenance costs and downtime, thereby impacting operational efficiency and profitability, as well as lifespan of the railcar. These effects compound over time, which can be particularly problematic for railcars expected to be in service for many years.

Embodiments of the present technology address at least some of these issues by providing a railcar assembly with reinforcement material disposed on the interior of the railcar. The reinforcement material can comprise a durable, erosion-resistant, and/or wear-resistant material that absorbs the impact of falling industrial product, mitigating and/or preventing damage to the interior surfaces of the railcar. In some embodiments, the reinforcement material is configured to be easily replaced to ensure continuous protection of the railcar interior over the life of the railcar. In some embodiments, the reinforcement material is configured as a removeable liner.

Some embodiments of the present technology disclose a reinforced railcar assembly configured to receive GMUs. The railcar assembly comprises a container envelope and reinforcement material. The container envelope includes rigid side walls and rigid end walls extending from a bottom surface (e.g., a floor) of the railcar. The side walls are a first length and the end walls are a second length less than the first length. Top portions of the rigid side walls and end walls define an opening of the container envelope through which industrial product is discharged into the railcar. In some embodiments, the railcar assembly includes angled interior walls coupled to the bottom surface and extending from a top portion of the end walls to the bottom surface. In some embodiments the angle of the internal walls is based on an angle of repose of the industrial product loaded into the railcar. The reinforcement material is disposed over a portion of the bottom surface and/or the angled interior walls, as these surfaces are likely to receive most of the impact from falling industrial product. In some embodiments, an open-topped box containing a layer of impact-absorbing material (also referred to herein as a “rock box” or “impact pad”), such as GMUs, is positioned on the bottom surface of the railcar. As industrial product is loaded into the railcar, the product impacts the layer of impact-absorbing material in the open-topped box, which absorbs the force of the falling product and protects the railcar interior.

The GMU production system is designed for continuous operation. Relative to non-continuous GPI production systems, embodiments of the present technology enhance energy efficiency and reduces emissions by minimizing the need for frequent shutdowns and restarts, which are often associated with excessive venting and/or less efficient operations. As described herein, some embodiments include (i) a desulfurization unit that lowers the sulfur content in molten metal, thereby reducing sulfur dioxide (SO₂) emissions, (ii) dust collection units that filter out particulate matter, thereby reducing air pollution, (iii) infrastructure to recycle fines, slag, iron skulls and other residual iron/previously-processed iron, thereby reducing the environmental impact associated with raw material extraction and conserving natural resources, (iv) reinforcement materials that greatly extend the life of GMU transport containers, such as railcars, thereby reducing waste associated with having to frequently replace railcars, and/or (v) water management and cooling systems that minimize heat losses, enhance thermal efficiency of production processes, and optimize water consumption. Overall, the continuous GMU production system enhances productivity while minimizing greenhouse gas emissions and waste, contributing to more sustainable industrial practices and helping mitigate climate change.

Relatedly, conventional iron production has a significant environmental impact due to its high energy consumption and emissions of pollutants. As such, embodiments of the present technology which relate to GMU production systems can reduce this impact. Sulfur, phosphorus, and silicon in GPI negatively affect the quality and properties of final metal products, leading to issues like reduced ductility, toughness, and weldability, as well as surface defects and brittleness. These impurities also contribute to the formation of non-metallic inclusions and excessive slag, complicating metal processing and compromising product quality. Sulfur, in particular, accelerates the wear and erosion of metal processing equipment, increasing maintenance costs and decreasing equipment lifespan. Embodiments of the present technology include methods for removing these impurities in part can improve the quality and durability of final metal products and enhances the efficiency and lifespan of processing equipment, leading to cost savings and more sustainable production practices.

In the FIGS., identical reference numbers identify generally similar, and/or identical, elements. Many of the details, dimensions, and other features shown in the FIGS. are merely illustrative of particular embodiments of the disclosed technology. Accordingly, other embodiments can have other details, dimensions, and features without departing from the spirit or scope of the disclosure. In addition, those of ordinary skill in the art will appreciate that further embodiments of the various disclosed technologies can be practiced without several of the details described below.

### II. Embodiments of a Continuous Granulated Metallic Unit Production System

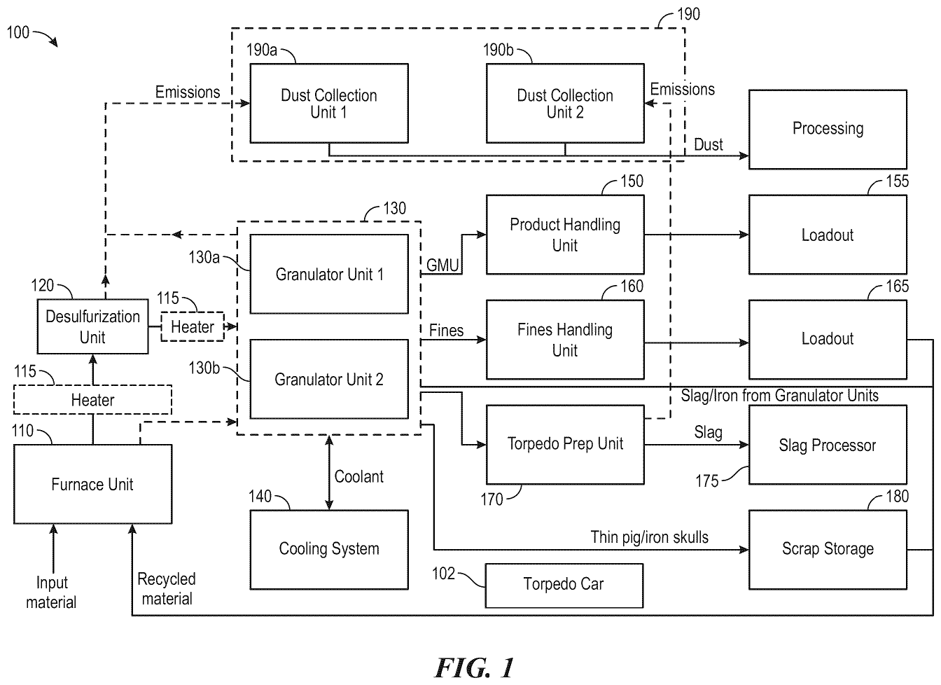

FIG. 1 is a schematic block diagram of a continuous GMU production system 100 (“the system 100”) configured in accordance with embodiments of the present technology. As explained elsewhere herein, GMUs can include granulated iron (GI), granulated pig iron (GPI), granulated steel (GS), or GMU. Relatedly, molten metal can include molten pig iron or molten steel. As used herein, the term “continuous” should be interpreted to mean continuous operations cycles, including in batch or semi-batch operations, for at least 4 hours, 6 hours, 8 hours, 10 hours, 12 hours, 16 hours, 20 hours, or 24 hours. The system 100 can include a furnace unit 110, a desulfurization unit 120, granulator units 130 including a first granulator unit 130a and a second granulator unit 130b, and a cooling system 140. The furnace unit 110 can receive input materials (e.g., iron ore, coke, limestone, and/or preheated air) and/or recycled material, which can be sourced from downstream components of the system 100 as described in further detail herein. Equations (1)-(6) below detail some of the chemical processes controlled at the furnace unit.

C+O₂→CO₂ (1)

CO₂+C→2CO (2)

Fe₂O₃+3CO→2Fe+3CO₂ (3)

Fe₂O₃+3C→2Fe+3CO (4)

CaCO₃→CaO+CO₂ (5)

CaO+SiO₂→CaSiO₃ (6)

Equation (1) represents the combustion of coke, which is a form of carbon. When coke reacts with oxygen gas introduced into the furnace (e.g., via an oxygen lance), it forms carbon dioxide. This exothermic reaction releases a significant amount of heat, which is essential for maintaining the high temperatures required for subsequent reactions. The carbon dioxide produced via Equation (1) further reacts with additional coke to form carbon monoxide, as illustrated by Equation (2). This endothermic reaction helps to moderate the temperature within the furnace unit 110. Equations (3) and (4) represent the reduction of iron ore (Fe₂O₃). As illustrated by Equation (3), the iron oxide reacts with the carbon monoxide produced via Equation (2), which acts as a reducing agent to convert iron ore into iron and produces carbon dioxide as a byproduct. Alternatively, as illustrated by Equation (4), the iron ore may be reduced directly by the coke, albeit less commonly. Equations (5) and (6) represent the formation of slag. As illustrated by Equation (5), the calcium carbonate/limestone (CaCO₃) can decompose into calcium oxide and carbon dioxide at the high temperatures of the furnace unit 110. As illustrated by Equation (6), the calcium oxide can then react with silica (SiO₂), an impurity in the iron ore, to form calcium silicate (CaSiO₃), also known as slag. The furnace unit 110 can output molten iron (from Equations (3) and (4)) and slag (from Equations (5) and (6)).

In some embodiments, the input materials (e.g., the coke, the iron ore, and/or the limestone) include sulfur, which can remain in the molten iron output by the furnace unit 110. A torpedo car 102 or other transfer vessel can transfer the molten iron from the furnace unit 110 to the desulfurization unit 120. The desulfurization unit 120 can include equipment to reduce the sulfur content of the molten iron. For example, one or more lances can be used to deliver magnesium (Mg), calcium carbide (CaC₂), or other sulfur-reducing agent to the molten iron. In some embodiments, the molten iron is desulfurized while remaining inside the torpedo car 102. Equations (7) and (8) below detail the reactions between the sulfur and the sulfur-reducing agents.

Mg+S→MgS (7)

CaC₂+S→CaS+2C (8)

The resulting substances, including magnesium sulfide (MgS) and calcium sulfide (CaS), are not soluble in molten iron and will therefore be in solid form (e.g., as solid particles) that can be more readily removed at the desulfurization unit 120 and/or further downstream. As discussed further herein, reducing the sulfur content can increase the quality of the GMU product and/or allow the production process to be continuous. After the desulfurization process, the torpedo car 102 can transfer the molten iron from the desulfurization unit 120 to the granulator units 130. In some embodiments, as indicated by the dashed arrow, the desulfurization unit 120 is bypassed and the molten iron is transferred directly from the furnace unit 110 to the granulator units 130. Notably, conventional facilities may not include a desulfurization unit or may otherwise lack the ability to desulfurize molten iron. One reason for this is that conventional steelmaking facilities directly feed molten iron from blast furnaces to basic oxygen furnaces, and opt to granulate the molten iron only when the basic oxygen furnaces are down. Because producing GPI is a backup operation for such facilities, the added complexity and costs associated with establishing desulfurization equipment may not be economical.

In some embodiments, the temperature of the molten iron is within a predetermined range prior to reaching the granulator units 130. For example, maintaining the molten iron in a sufficiently fluid state can better ensure the formation of uniform granules and help avoid premature solidification, which can lead to irregular granule shapes and sizes. In some embodiments, the system includes one or more heaters 115 before and/or after the desulfurization unit 120, e.g., to reheat the molten iron within the torpedo car 102. For example, if the temperature of the molten iron is below a threshold temperature value, the heater 115 can be used to raise the temperature of the molten iron in the torpedo car 102 to be within a desired temperature range. The threshold temperature value can vary between different compositions, and can be between 2300-2500° F., between 2300-2400° F., or between 2340-2350° F. In some embodiments, the heater 115 comprises one or more oxygen lances.

The torpedo car 102 can transfer the molten iron to one of the granulator units 130. While FIG. 1 illustrates two granulator units 130, it will be understood that the system 100 can include one, three, four, five, six, or more granulator units 130. The granulator units 130 can each include a granulation reactor that receives and granulates molten iron to form granulated products. For example, the granulation reactor can include a cavity that holds water, and the molten iron can be transferred (e.g., poured, sprayed) onto a target of the reactor holding the water. The water can be maintained at a sufficiently low temperature by the cooling system 140 (e.g., cooled directly by pumping the water between the granulator units 130 and the cooling system 140, cooled indirectly by pumping a coolant separate from the water that receives the molten iron). In some embodiments, the granulator units 130 each includes one or more components for controlling the flow of molten iron from the torpedo car 102 to the granulation reactor. As one of ordinary skill in the art will appreciate, flow control can affect the shape, size, and quality of the granulated products. The granulator units 130 can also include a dewatering assembly for drying the granulated products from the granulation reactor to output GMU. The granulator units 130 can further include a classifier assembly for filtering the filtrate from the dewatering assembly to output fines.

The system 100 can further include a product handing unit 150 to receive the GMU output by the granulator units 130 (e.g., by the dewatering assembly), and a loadout 155 downstream of the product handling unit 150. Additionally, the system 100 can further include a fines handling unit 160 to receive the fines output by the granulator units 130 (e.g., by the classifier assembly), and a loadout 165 downstream of the fines handling unit 160. In some embodiments, the product handling unit 150 and/or the fines handling unit 160 each includes one or more conveyor belts, diverters, stockpile locations, etc. The system 100 can additionally include a torpedo preparation unit 170 that can remove slag and/or kish from the torpedo car 102. For example, the torpedo car 102, after delivering the molten iron to the granulator units 130, can proceed to the torpedo prep unit 170 to be cleaned or otherwise prepared for the next cycle of transferring molten iron. The removed slag can be subsequently transferred to a slag processor 175. The system 100 can further include a scrap storage 180 that can receive thin pig and/or iron skulls from the granulator units 130.

As shown in FIG. 1, the fines at the loadout 165, slag and/or iron from the granulator units 130, and/or the thin pig and/or iron skulls at the scrap storage 180 can be fed back into the furnace unit 110 as recycled materials. In some embodiments, the recycled materials are processed (e.g., pelletized) prior to being fed into the furnace unit 110. Furthermore, emissions from various components of the system 100 can be collected and directed towards a dust collection unit 190 (e.g., a baghouse, a scrubber, etc.). In FIG. 1, for example, the emissions from the desulfurization unit 120 and the granulator units 130 are directed to a first dust collection unit 190a, and the emissions from the torpedo prep unit 170 are directed to a second dust collection unit 190b. Each of the dust collection units 190 can filter the emissions to remove dust therefrom so that clean waste gas is sent to stacks (not shown) to be released into the atmosphere, and the removed dust can be directed to further processing.

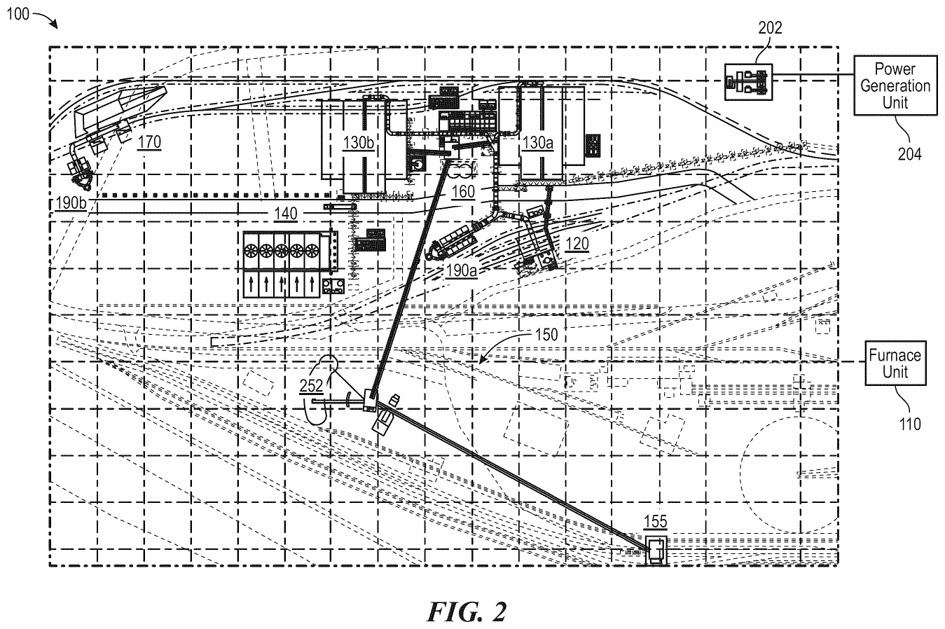

FIG. 2 is a plan view of the continuous GMU production system 100. It will be appreciated that the plan view illustrated in FIG. 2 is merely one example, and that the components of the system 100 can be arranged differently in other embodiments. As shown, the system 100 can further include an electrical building 202 and a power generation unit 204 for providing electrical power to the system 100. As discussed further herein, one or more of the components of the system 100 can be powered electrically as opposed to, e.g., hydraulically. The furnace unit 110 can be located away from many of the other components of the system 100. The torpedo car 102 or other transfer vessel (not shown) can transfer the molten iron from the furnace unit 110 to the desulfurization unit 120 along tracks illustrated in dashed lines.

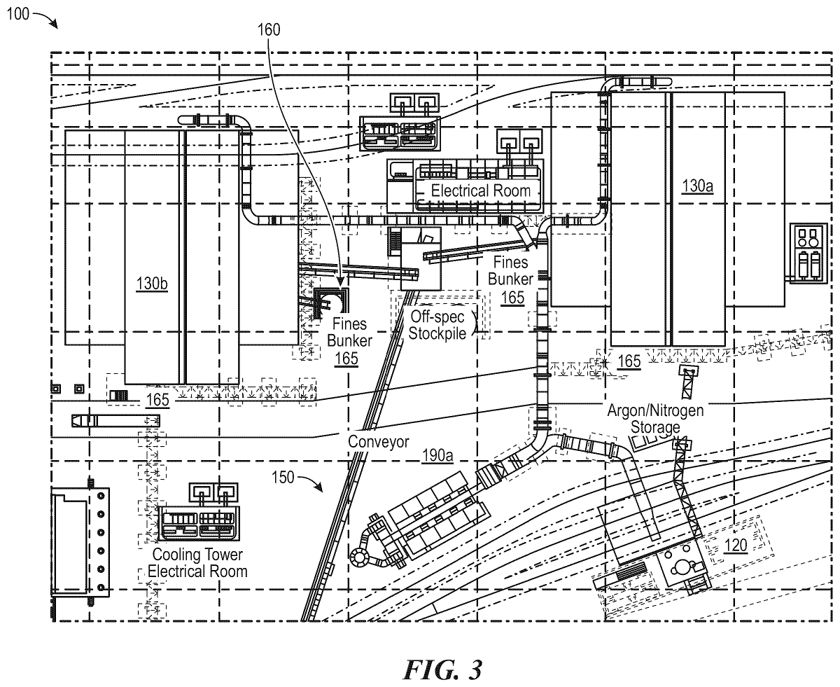

Referring momentarily to FIG. 3, which is an enlarged plan view of the system 200, the desulfurization unit 120 can desulfurize the molten iron while the molten iron remains in the torpedo car 102. Once the molten iron is desulfurized, the torpedo car 102 can continue along the tracks to the granulator units 130. The torpedo car 102 can deliver the molten iron to either of the first granulator unit 130a or the second granulator unit 130b depending on, e.g., the availability of each of the granulator units 130. The GMU produced by each of the granulator units 130 can be transferred downstream via one or more conveyor belts that form part of the product handling unit 150. The fines produced by each of the granulator units 130 can be transferred to fines bunkers located adjacent to the granulator units 130 and ultimately sent to the loadout(s) 165. As shown in FIG. 3, the first dust collection unit 190a can be connected to each of the desulfurization unit 120 and the granulator units 130 via pipes to collect emissions therefrom.

Returning to FIG. 2, the cooling system 140 can be located adjacent to the granulator units 130 to provide cooling thereto as needed. The product handling unit 150 can include a stockpile area 252 for storing GMU products. One or more conveyor belts can extend between each of the granulator units 130 and the stockpile area 252, and between the stockpile area 252 and the loadout 155. In some embodiments, the loadout 155 comprises a building at which a desired quantity of GMUs can be measured and transferred to a railcar or other transfer vehicle. In some embodiments, the GMUs is subsequently transferred to an electric arc furnace (not shown) for steel production. The torpedo car 102, after delivering the molten iron to the granulator units 130, can continue along the tracks to reach the torpedo prep unit 170. As discussed above with reference to FIG. 1, the torpedo prep unit 170 can facilitate removal of slag and/or kish from the torpedo car 102. The second dust collection unit 190b can be connected to the torpedo prep unit 170 via pipes to collect emissions therefrom.

Referring to FIGS. 1-3 together, the system 100 is expected to be able to continuously produce GMU, unlike conventional GMU production systems. First, the inclusion of the desulfurization unit 120 provides several advantages. For example, GMUs with lower sulfur content produces less slag when melted at an electric arc furnace downstream, saving associated time, costs, and energy consumption. The use of GMUs with lower sulfur content can also ease maintaining the desired chemical composition and temperature, reducing the frequency of adjustments and interruptions during the melting cycle. Lower sulfur levels can also result in less wear and tear on other components of the system, reducing maintenance needs and associated downtime.

Second, the inclusion of a plurality of granulator units 130 allows molten iron to be granulated at separate granulator units in parallel. The granulator units 130 can also serve as backups for one another in case one of the granulator units 130 is down (e.g., due to malfunctioning components, maintenance, etc.). Furthermore, in some embodiments, the various components of the granulator units 130 are modular. For example, each of the components can be easily and independently removed (e.g., for maintenance) and/or replaced (e.g., via an overhead crane) without impacting operation of the other components.

### III. Reinforced Railcar Apparatuses, Systems, and Methods

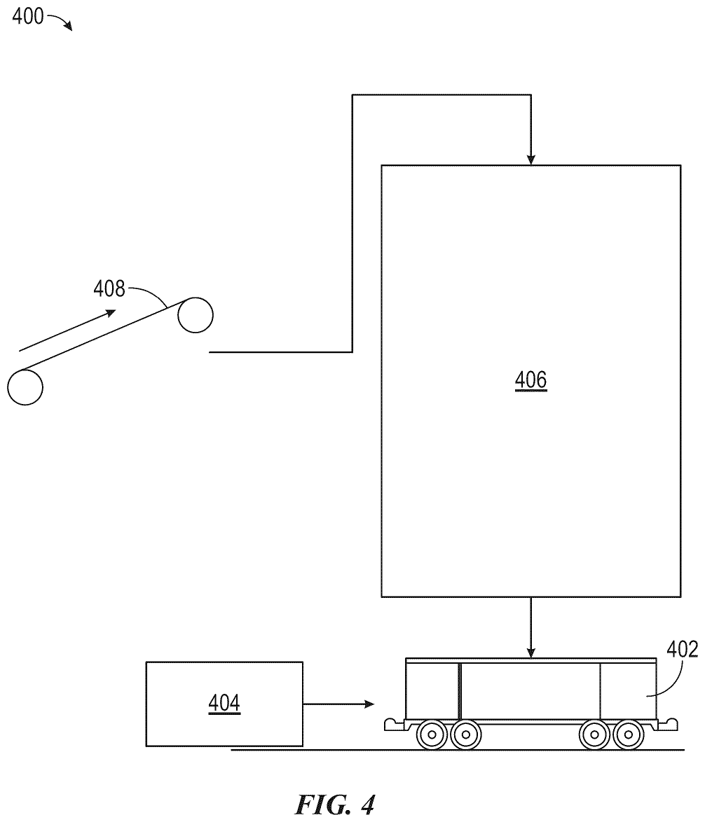

FIG. 4 is a schematic illustration of a system 400 for loading GMUs into a railcar 402 in accordance with embodiments of the present technology. In some embodiments, one or more components of the system 400 are generally similar to/identical to loadout 155 discussed with reference to FIG. 1. The system 400 includes a conveyer mechanism 408 and a housing unit 406 positioned to receive materials conveyed via the conveyor mechanism 408. The housing unit 406 can be configured with various components (e.g., a surge bin, a weigh bin, etc., not pictured), e.g., to measure the desired quantity of GMUs before transferring it to the railcar 402. In some embodiments, system 400 further includes a railcar movement mechanism 404 (e.g., a railcar mover) configured to move the railcar 402 throughout various stages of the loadout process.

In operation, the GMUs can be transported via the conveyer mechanism 408 to the housing unit 406. The conveyer mechanism 408 is inclined to provide the GMUs to measuring/weighing components of the housing unit 406, which are positioned at a relatively high point with reference to ground. The measuring/weighing components measure the desired quantity of GMUs, and the quantity of GMUs is transferred via gravity to the railcar 402 positioned beneath the components of the housing unit 406. In some embodiments, as the railcar 402 receives the quantity of GMUs, the railcar movement mechanism 404 repositions the railcar 402 to assist with spreading out the load in the railcar 402.

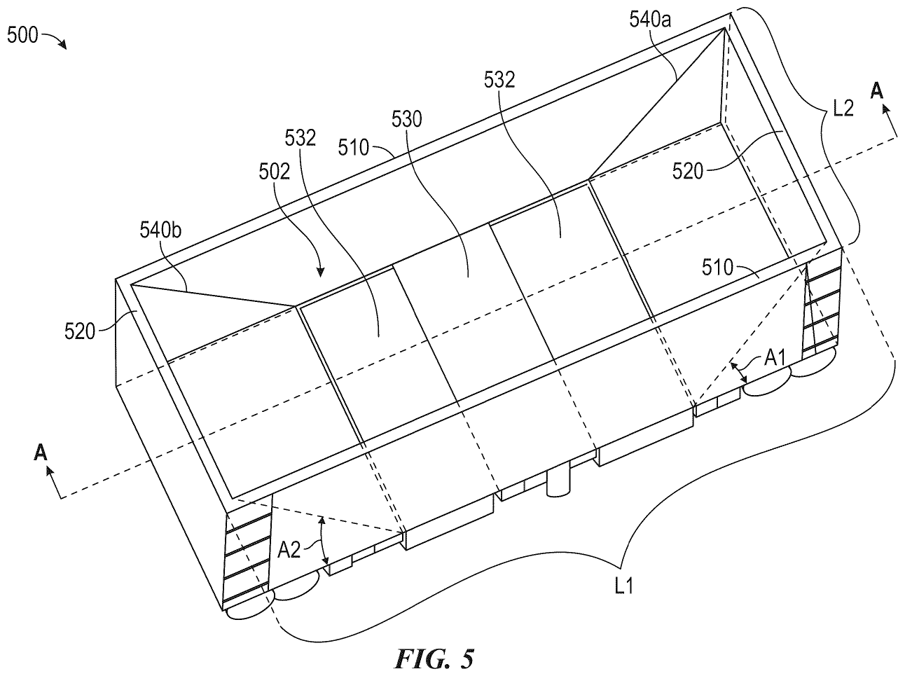

FIG. 5 is a partially schematic perspective view of a railcar 500 in accordance with embodiments of the present technology. The railcar 500 includes a container envelope configured to receive the GMUs. The container envelop includes a bottom surface 530 (also referred to as a floor), and multiple side walls 510 (e.g., two side walls 510 in the present embodiment) that extend from the floor 530. The side walls 510 have a first length L1 and are approximately perpendicular to the floor 530, with an angle between 80-100 degrees relative to the floor 530. The container envelope further includes multiple end walls 520 (e.g., two end walls 520 in the present embodiment) that extend from the floor 530 and are positioned between the side walls 510. In some embodiments, the end walls 520 are also approximately perpendicular to the floor 530. In some embodiments, the end walls 520 are angled with respect to the floor 530 and/or one or more doors and/or gates 532 (discussed further herein). These end walls 520 have a second length L2, which is shorter than the first length L1. In some embodiments, the container envelope also includes angled interior walls 540, each of which is coupled to the floor 530, the side walls 510, and one of the end walls 520. In some embodiments, the angled interior walls 540 are angled with respect to the floor 530 and/or one or more doors and/or gates 532, e.g., based on an angle of repose of the GMU to be received by the railcar 500. A benefit of angling the angled interior walls 540 based on the angle of repose is to ensure that GMU is efficiently discharged via, for example, the one or more doors and/or gates 532. In some embodiments, the angled interior walls 540 are omitted. Top portions of the side walls 510 and end walls 520 define an open top 502 of the container envelope, through which GMUs pass during loading into the container envelope. In some embodiments, approximately no more than two feet of GMUs are loaded in the railcar (e.g., to avoid exceeding rail line weight limits).

In some embodiments the angle of repose of the GMUs can be between 15-30 degrees, 30-45 degrees, 45-60 degrees, 60-75 degrees, or 75-90 degrees, or at least 30 degrees, 35 degrees, 40 degrees, 45 degrees, 50 degrees, 55 degrees, 60 degrees, 65 degrees, 70 degrees, 75 degrees, 80 degrees, or 85 degrees, or any incremental value therebetween (e.g., at least 33 degrees). In some embodiments, the angle of repose can be determined using one or more methods including: a tilting box (e.g., slowly tilting a box until the product begins to slide in bulk and measuring the tilt angle), a fixed funnel (e.g., pouring the product through a funnel to form a cone), a static or revolving cylinder (filling a cylinder with the product and measuring the angle of the product against the wall of the cylinder), and the like. In some embodiments, the angles of the angled interior walls 540 and/or the end walls 520 form angles A1, A2 between 15-30 degrees, 30-45 degrees, 45-60 degrees, 60-75 degrees, or 75-90 degrees relative to the floor 530 and/or gates 532. In some embodiments, the angles A1, A2 are at least 30 degrees, 35 degrees, 40 degrees, 45 degrees, 50 degrees, 55 degrees, 60 degrees, 65 degrees, 70 degrees, 75 degrees, 80 degrees, or 85 degrees relative to the floor 530 and/or gates 532. In some embodiments angle A1 is different than angle A2.

In some embodiments, the railcar 500 is also configured to unload GMUs contained in the container envelope through the one or more doors and/or gates 532 positioned in the floor 530. These doors and/or gates 532 can open in a longitudinal direction (e.g., “Bombay” doors) or in a transverse direction with respect to the floor 530. In some examples, a longitudinal beam is integrated along the middle of the floor 530 to help structurally support the doors and/or gates 532. In some embodiments, the container envelope is configured with relatively low side walls 510, no greater than 4 feet high from the floor 530.

In operation, the desired quantity of GMUs is discharged (e.g., dropped) into the container envelope of the railcar 500 through the open top 502. In some embodiments, the GMUs are initially discharged into a center section of the floor 530 (e.g., between the gates 532 of the present embodiment). As the container envelope fills with GMUs, a pile is formed that spreads out along the floor 530 and up the side walls 510 and angled interior walls 540 (or end walls 520 if the angled interior walls 540 are omitted). In some embodiments, to assist with spreading the pile throughout the container envelope, the railcar 500 is repositioned at various times (continuously or iteratively) under the source of the discharge.

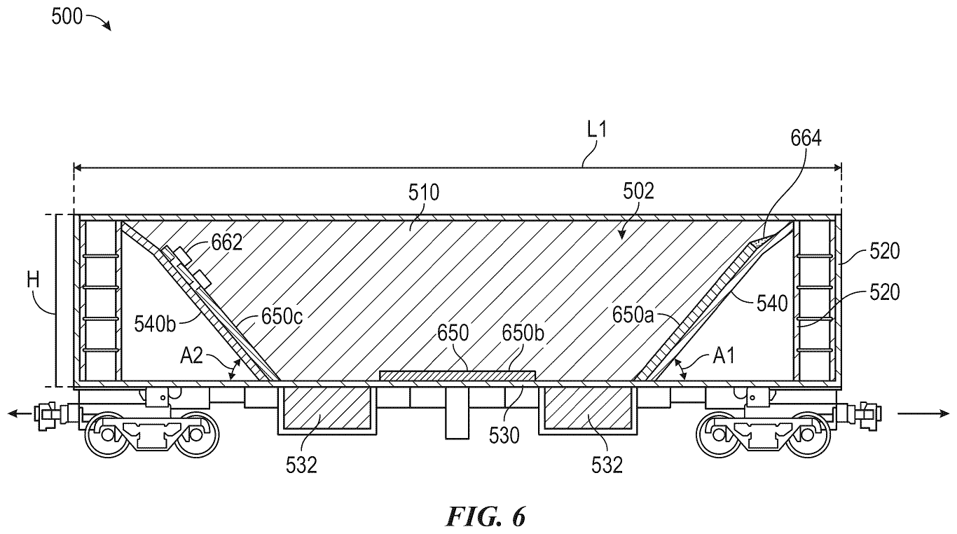

FIG. 6 is a partially schematic cross-sectional view of the railcar 500 of FIG. 5 at line A-A in accordance with embodiments of the present technology. In the present embodiment, the railcar 500 comprises a container envelope with a reinforcement material or liner 650 (“reinforcement material 650”) disposed over at least portions of the floor 530 and/or angled interior walls 540. The reinforcement material 650 can comprise multiple distinct sections 650a, 650b, 650c, which can be plates, panels, sheets, slabs, or claddings. In the present embodiment, section 650a is disposed over at least a portion of a first angled interior wall 540a, section 650b is disposed over at least a portion of the floor 530, and section 650c is positioned over at least a portion of a second angled interior wall 540b. In some embodiments, the section of the reinforcement material 650b disposed over the floor 530 is positioned such that it spans the area between the side walls 510 and the gates 532. In some embodiments, the reinforcement material 650 is also disposed over a portion of the rigid side walls 510.

In some embodiments, each of the sections 650a, 650b, 650c is made from a hardened material with high wear resistance, such as steel (e.g., carbon steel, abrasion-resistant (AR) steel, and/or Hardox®), refractory lining (e.g., magnesia, alumina, silica, and the like), polyurethane, or other metals and/or metal alloys (e.g., silicon carbide, tungsten carbide, and/or titanium alloy). In some embodiments, one or more of the side walls 510, end walls 520, angled interior walls 540, and/or floor 530 are made from a hardened material with high wear resistance, similar to the materials used for the reinforcement material 650. In some embodiments the reinforcement material 650 (e.g., sections 650a, 650b, 650c) is comprised of different hardened materials than the side walls 510, end walls 520, angled interior walls 540, and/or floor 530. In some embodiments, one or more of the sections 650a, 650b, 650c are comprised of different materials from each other. For example, section 650b can be comprised of AR steel, while sections 650a and 650c can be comprised of silicon carbide. In some embodiments, one or more of the reinforcement material 650, side walls 510, end walls 520, angled interior walls 540, and floor 530 may be comprised of steel with 0.02% copper content to further reduce wear and corrosion.

Adding the reinforcement material 650 to the railcar 500 can enhance the durability of the railcar 500 by positioning one or more reinforced sections (e.g., 650a, 650b, 650c) throughout the railcar 500 to absorb the impact of GMUs as they are discharged into the container envelope. This reduces the frequency of maintenance and repairs, thereby extending the service life of the railcar 500. The use of hardened materials in the reinforcement material 650 and/or the side walls 510, end walls 520, floor 530, and angled interior walls 540 helps to minimize wear and corrosion over the life of the railcar 500.

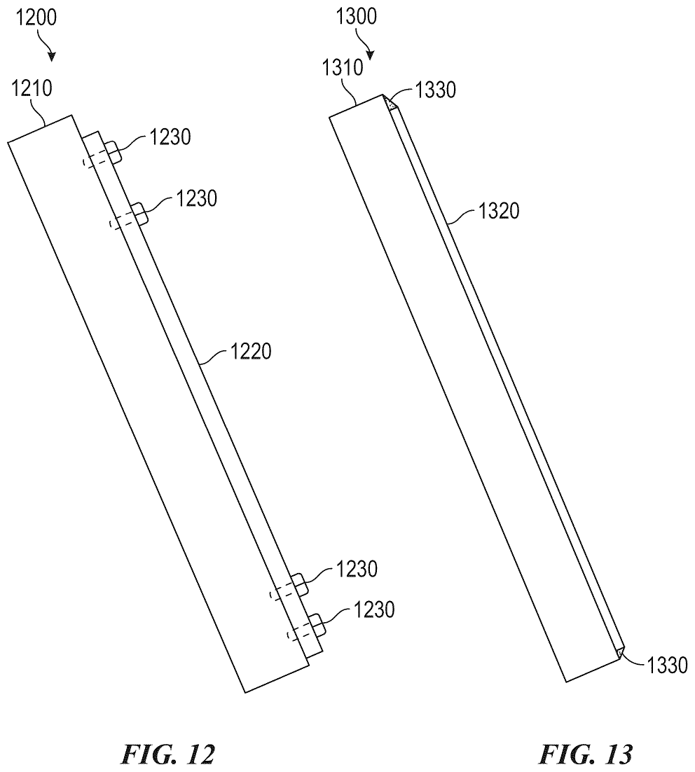

In some embodiments, the reinforcement material 650 is coupled to the container envelope (e.g., the side walls 510, end walls 520, angled interior walls 540, and/or floor 530) via one or more coupling mechanisms, such as bolts 660, tack welding 662, fasteners, clamps, clips, hangers, hooks, and the like. These are discussed further in FIGS. 12-15C. In some embodiments, these coupling mechanisms are designed to make the reinforcement material 650 easily removable from the container envelope, simplifying replacement and repair, and adding customizability to the railcar 500. For example, when transporting GPI, additional sections of the reinforcement material 650 can be easily installed in the container envelope. Conversely, when transporting a lower-density industrial product, the reinforcement material 650 can be easily removed, reducing the unladen weight of the railcar 500 and allowing for more product to be loaded.

In some embodiments, the overall size of the railcar 500 is reduced relative to many railcar configurations. For example, in some embodiments, the length L1 of the railcar 500 is no greater than 50 feet (e.g., 46 feet, 44 feet, 42 feet, etc.). In some embodiments, the height H of the railcar 500 is no greater than 4 feet (e.g., 3 feet, 2 feet, etc.). By reducing the overall size of the railcar 500, more GMUs can be added to the railcar 500 before reaching certain gross rail line weight limits (e.g., 268,000 pounds).

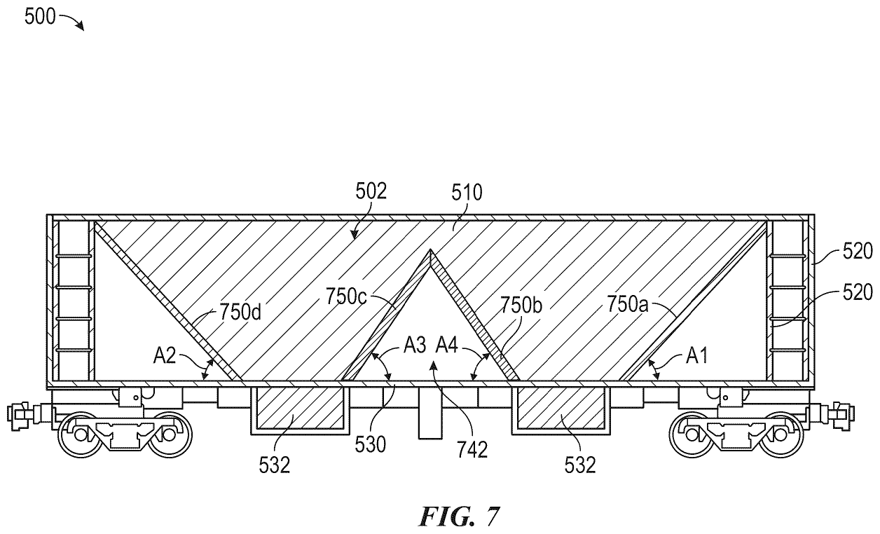

FIG. 7 is a partially schematic cross-sectional view of the railcar 500 of FIG. 5 at line A-A in accordance with additional embodiments of the present technology. In the present embodiments, railcar 500 includes similar features to those discussed in FIG. 5 and FIG. 6, with the exception that railcar 500 has omitted angled interior walls, and includes a raised divider 742 positioned between the gates 532. Reinforcement material sections 750a and 750d are configured to extend off of the top portions of the rigid end walls 520 and to contact the floor 530 at angles A1, A2. In some embodiments, angles A1, A2 are based on angles of repose of GMU expected to be loaded and/or loaded in the container envelope. In some embodiments, the sections 750a, 750d are coupled to the top portions of the end walls 520 and the floor 530 via one or more of the coupling mechanisms discussed in FIG. 6 and FIGS. 12-15C. The raise divider 742 contacts the floor 530 at angles A3, A4. In some embodiments, angles A3, A4 are based on angles of repose of GMU expected to be loaded and/or loaded in the container envelope. In some embodiments, the angles of the raised divider 742 A3, A4 are between 15-30 degrees, 30-45 degrees, 45-60 degrees, 60-75 degrees, or 75-90 degrees, relative to the floor 530 and/or gates 532. In some embodiments, the angles A3, A4 are at least 25 degrees, 30 degrees, 35 degrees, 40 degrees, 45 degrees, 50 degrees, 55 degrees, 60 degrees, 65 degrees, 70 degrees, 75 degrees, 80 degrees, or 85 degrees relative to the floor 530 and/or gates 532. In some embodiments angle A3 is different than angle A4.

In some embodiments, the reinforcement material sections 750b, 750c are disposed over at least a portion of the divider 742. By configuring the container envelope in this way, reinforcement sections 750a, 750c can provide protection to the end walls 520 and floor 530 while simultaneously holding loaded GMUs such that the GMUs will easily discharge out of the gates 532 when the gates 532 are opened.

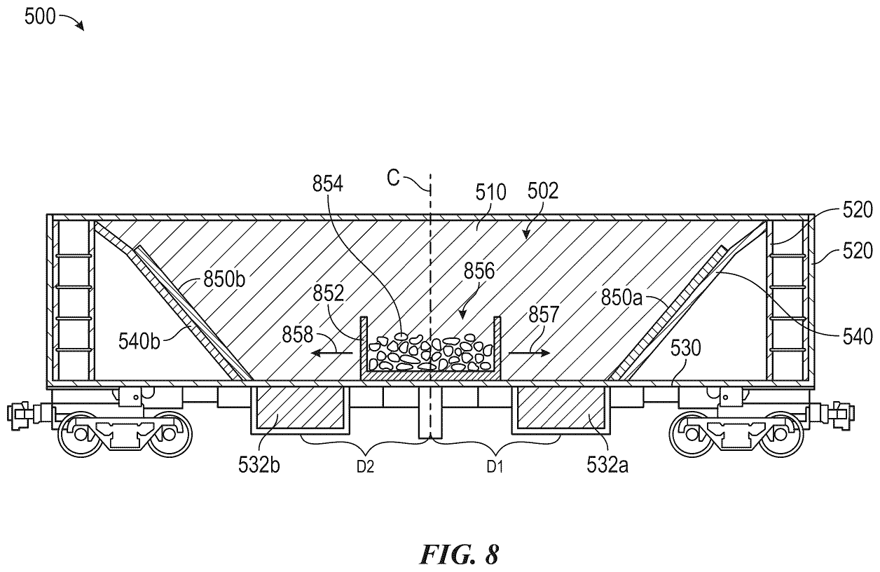

FIG. 8 is a partially schematic cross-sectional view of the railcar 500 of FIG. 5 at line A-A in accordance with additional embodiments of the present technology. The present embodiment is generally similar/identical to the embodiment of FIG. 6, with the addition of a rock box 852. Reinforcement sections 850a and 850b are disposed over angled interior walls 540a and 540b, respectively. As shown in FIG. 8, the rock box 852 (also referred to as an impact pad) has an open top 856 containing a layer (e.g., 4-5 inches) of granulated material 854, such as GMU, GI, GPI, GS, aggregate rock, or the like. Rock box 852 is positioned so as to absorb at least some of the impact force of GMUs being loaded into the railcar 500. In some embodiments, the rock box 852 is positioned at an intermediate region along a length of the container. For example, the rock box 852 can be positioned at an intermediate region or center point C of the floor 530 and/or container envelope, where it is expected that an initial portion of the quantity of GMUs will impact the railcar 500 during the loading process. In some embodiments, the rock box 852 is offset a distance from the intermediate region and/or center point C. In some embodiments, the rock box 852 spans the area between multiple gates 532a, 532b. For example, a first gate 532a can be offset a first distance D1 from center point C in a first direction 857, and a second gate 532b can be offset a second distance D2 from center point C in a second direction 858 opposite the first direction 857. The rock box 852 can span at least a portion of the area including D1 and D2 and between the rigid side walls 510. In some embodiments, the distances D1 and D2 are approximately equivalent. In some embodiments, the layer of granulated material is an aggregate rock material.

The rock box 852 provides a relatively low-weight solution mitigating wear and erosion of the interior of the railcar 500. Positioned at or near the expected area where GMUs will initially impact the railcar 500, (e.g., center point C of the floor 530 and/or container envelope), the rock box 852 can absorb a substantial portion of the impact force exerted by GMUs during the loading process. By cushioning the initial impact, the rock box 852 helps to prevent damage and wear to the interior surfaces of the railcar 500, thereby extending the service life of the railcar and reducing maintenance costs. The granulated material layer 854 within the rock box 852 also offers the advantage of flexibility and adaptability. The granulated material 854 can be easily replaced or replenished as needed, ensuring that the rock box 852 remains effective in absorbing impact forces over multiple loading cycles. This adaptability is particularly useful when transporting different types of materials, as the granulated layer 854 can be adjusted to suit the specific properties of the cargo being loaded.

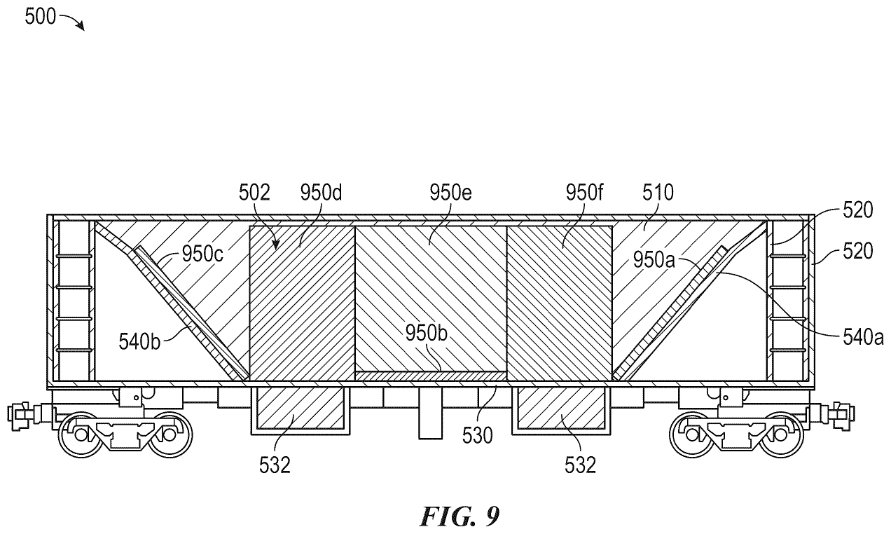

FIG. 9 is a partially schematic cross-sectional view of the railcar 500 of FIG. 5 at line A-A in accordance with additional embodiments of the present technology. The present embodiments are generally similar/identical to the embodiments shown in FIG. 6, with the exception that railcar 500 includes further includes additional reinforcement sections 950d, 950e, and 950f. Thus, the reinforcement material of the present embodiment is comprised of section 950a disposed over angled interior wall 540a, section 950b disposed over part of floor 530, section 950c disposed over angled interior wall 540b, and sections 950d, 950e, and 950f disposed over portions of one or more of the rigid side walls 510.

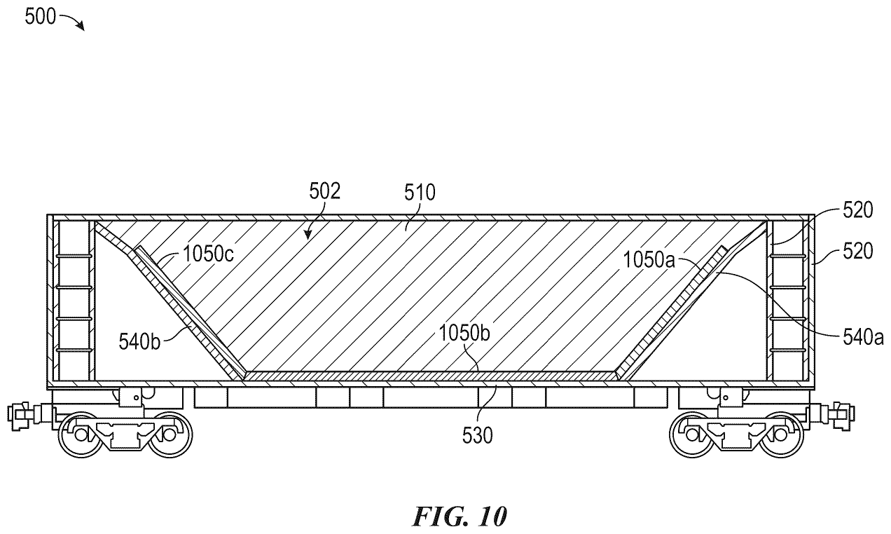

FIG. 10 is a partially schematic cross-sectional view of the railcar 500 of FIG. 5 at line A-A in accordance with additional embodiments of the present technology. The present embodiments are generally similar/identical to the embodiments shown in FIG. 6, with the exception that the doors and/or gates 532 are omitted (for example, in a gondola type railcar), and reinforcement section 1050b extends the length of the floor 530 between the areas where the angled interior walls 540a, 540b meet the floor 530. Thus, the reinforcement material 1050 is comprised of section 1050a disposed over angled interior wall 540a, section 1050b disposed over substantially all of the floor 530, and section 1050c disposed over angled interior wall 540b.

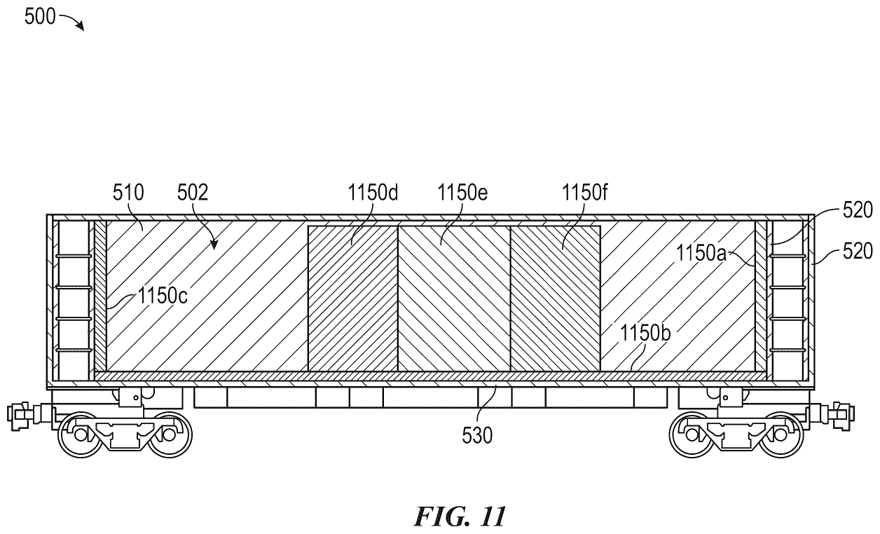

FIG. 11 is a partially schematic cross-sectional view of the railcar 500 of FIG. 5 at line A-A in accordance with additional embodiments of the present technology. The present embodiment is generally similar/identical to the embodiment of FIG. 10 with the exception that the present embodiment further omits angled interior walls 540, reinforcement sections 1150a and 1150c are disposed over end walls 520, and reinforcement sections 1150d, 1150e, and 1150f are disposed on at least a portion of the side walls 510. Section 1150b is disposed on substantially the length of the floor 530, and spans the area between the end walls 520 and the side walls 510.

FIG. 12 is a partially schematic side view of a mechanism 1200 for coupling a reinforcement material 1220 to a railcar in accordance with embodiments of the present technology. The coupling mechanism 1200 includes one or more bolts 1230 used to couple the reinforcement material 1220 to an interior surface 1210 (e.g., any of the side walls, end walls, angled interior walls, and/or floor disclosed in this document) of the container envelope. In some embodiments, the bolts 1230 are countersunk such that the bolt heads of the bolts 1230 are at least approximately flush with the reinforcement material 1220. It will be appreciated that one skilled in the art would recognize that the coupling mechanism 1200 can be used in any of the railcar embodiments and in combination with any other coupling mechanisms disclosed herein.

FIG. 13 is a partially schematic side view of a mechanism 1300 for coupling a reinforcement material 1320 to a railcar in accordance with additional embodiments of the present technology. The coupling mechanism 1300 is comprised of one or more tack welds 1330 coupling the reinforcement material 1320 to an interior surface 1310 of the container envelope. The coupling mechanism 1300 can be used in any of the railcar embodiments and in combination with any other coupling mechanisms disclosed herein.

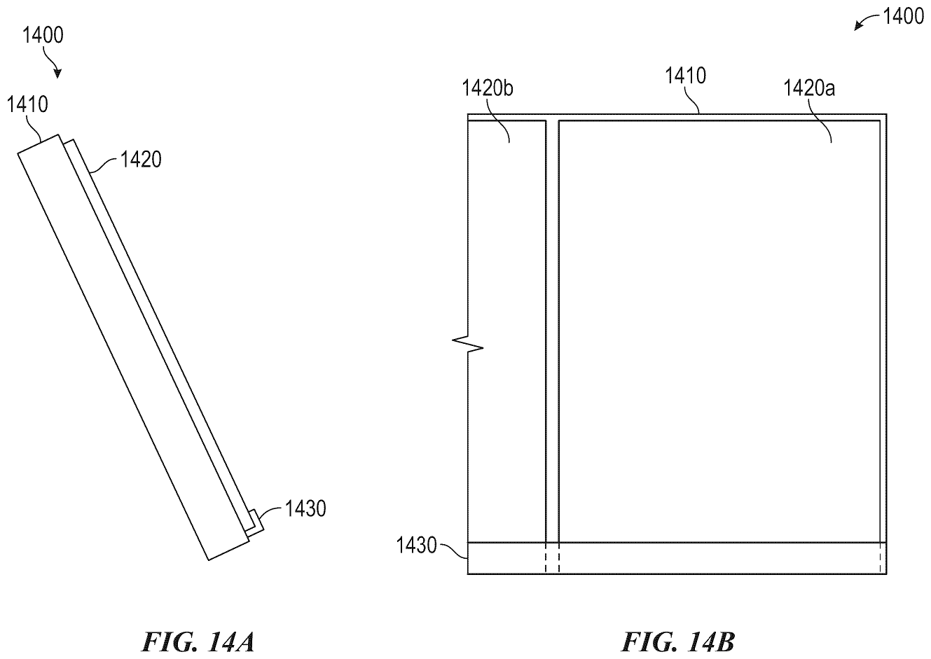

FIG. 14A is a partially schematic side view of a mechanism 1400 for coupling a reinforcement material 1420 to a railcar in accordance with additional embodiments of the present technology. FIG. 14B is a partially schematic front view of the mechanism 1400 of FIG. 14A. Referring to FIGS. 14A and 14B together, the coupling mechanism 1400 includes a clamping slot 1430 positioned along an edge of an interior surface 1410 of the container envelope and is used to clamp reinforcement material 1420 in place against the interior surface 1410 of the container envelope. For example, the clamping slot 1430 can be positioned along the bottom edge of the rigid side walls (e.g., side walls 510) where the side walls meet the floor of the railcar (e.g., floor 530). One or more reinforcement sections 1420a, 1420b can be fitted into the clamping slot 1430, and clamped against the interior surface 1410 via the clamping slot 1430. Coupling mechanism 1400 can be used in any of the railcar embodiments and in combination with any other coupling mechanisms disclosed herein.

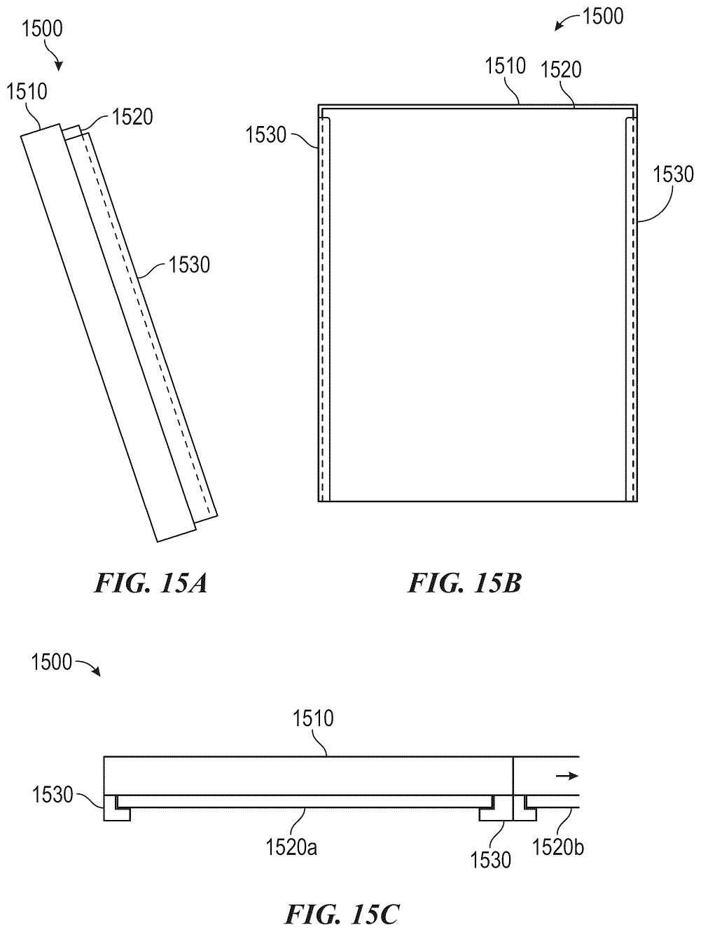

FIG. 15A is a partially schematic side view of a mechanism 1500 for coupling a reinforcement material 1520 to a railcar in accordance with additional embodiments of the present technology. FIG. 15B is a partially schematic front view of the mechanism 1500 of FIG. 15A. FIG. 15C is a partially schematic top view of the mechanism 1500 of FIG. 15A. Referring to FIGS. 15A-15C together, the coupling mechanism 1500 includes a plurality of clamping slots 1530 positioned at multiple locations along an interior surface 1510 of the container envelope and configured to clamp the reinforcement material 1520 to the interior surface 1510 of the container envelope. The plurality of clamping slots 1530 can be configured to accommodate individual reinforcement sections 1520a, 1520b, such that each section 1520a, 1520b is clamped on opposing edges. The coupling mechanism 1500 can be used in any of the railcar embodiments and in combination with any other coupling mechanisms disclosed in this document.

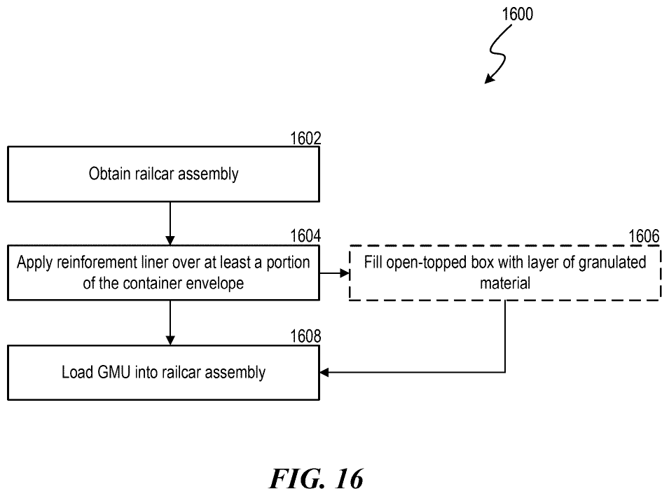

FIG. 16 is a flowchart illustrating a method 1600 of loading GMUs into a reinforced railcar in accordance with embodiments of the present technology. At block 1602 of method 1600, a railcar assembly is obtained. The railcar assembly includes an open-top container envelope comprised of a bottom surface (also referred to as a floor), rigid side walls of a first length, rigid end walls of a second length less than the first length, and angled interior walls that are angled based on an angle of repose of granulated iron. At block 1604, a reinforcement material (also referred to as a liner) is applied over at least a portion of the container envelope. In some embodiments, the reinforcement material is applied to at least a portion of the bottom surface and one or more of the angled interior walls. At optional block 1606, in configurations in which the container envelope includes a rock box, the rock box is filled with a layer of granulated material (e.g., GMUs, GI, GS, GPI). At block 1608, GMUs are loaded into the railcar assembly via the open top of the container envelope.

### IV. Conclusion

It will be apparent to those having skill in the art that changes may be made to the details of the above-described embodiments without departing from the underlying principles of the present technology. In some cases, well known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Throughout this disclosure, the singular terms “a,” “an,” and “the” include plural referents unless the context clearly indicates otherwise. The term “comprising,” “including,” and “having” should be interpreted to mean including at least the recited feature(s) such that any greater number of the same feature and/or additional types of other features are not precluded.

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numbers expressing concentrations and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10, i.e., any and all subranges having a minimum value of equal to or greater than 1 and a maximum value of equal to or less than 10, e.g., 5.5 to 10.

The disclosure set forth above is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

The present technology is illustrated, for example, according to various aspects described below as numbered clauses or embodiments (1, 2, 3, etc.) for convenience. These are provided as examples and do not limit the present technology. It is noted that any of the dependent clauses can be combined in any combination, and placed into a respective independent clause.

1. A reinforced railcar assembly used for the transport of granulated metallic units (GMUs), the assembly comprising:
a container envelope comprising:
   a bottom surface;
   rigid side walls extending from the bottom surface, wherein the rigid side walls each have a first length and are approximately perpendicular to the bottom surface;
   rigid end walls extending from the bottom surface and between the rigid side walls, wherein the rigid end walls have a second length less than the first length; and
   angled interior walls, wherein each of the angled interior walls is coupled to the bottom surface, the rigid side walls, and one of the rigid end walls,
   wherein top portions of each of the rigid side walls and rigid end walls define an opening of the container envelope configured to receive the GMUs; and
a reinforcement material disposed over a portion of the bottom surface and/or the angled interior walls.

2. The railcar assembly of any one of the clauses herein, wherein the reinforcement material is a removeable liner from the container envelope.

3 The railcar assembly of any one of the clauses herein, wherein the reinforcement material is coupled to the container envelope via one or more of: tack welding, bolting, fastening, clamping, clipping, and hanging to the container envelope.

4. The railcar assembly of any one of the clauses herein, wherein the reinforcement material is comprised of one or more rigid plates.

5. The railcar assembly of any one of the clauses herein, wherein the reinforcement material is comprised of one or more of: metal, metal alloy, metal cladding, and polyurethane.

6. The railcar assembly of any one of the clauses herein, wherein the reinforcement material is further disposed over a portion of the rigid side walls.

7. The railcar assembly of any one of the clauses herein, wherein the container envelope further includes an impact pad configured to absorb the impact of GMUs dropped from a height.

8. The railcar assembly of any one of the clauses herein, wherein the impact pad is positioned at approximately a center point along the length of the container envelope.

9. The railcar assembly of any one of the clauses herein, wherein the impact pad is an open-topped container containing a layer of GMUs.

10. The railcar assembly of any one of the clauses herein, wherein the layer of GMUs is granulated pig iron (GPI).

11. The railcar assembly of any one of the clauses herein, wherein the bottom surface includes a gate configured to discharge GMUs contained in the container envelope.

12. The railcar assembly of any one of the clauses herein, wherein (i) the gate is a first gate, (ii) the bottom surface includes a second gate configured to discharge GMUs contained in the container envelope, and (iii) the first gate is a first distance in a first direction from a center point of the bottom surface and the second gate is a second distance in a second direction, opposite the first direction, from the center point of the bottom surface.

13. The railcar assembly of any one of the clauses herein, wherein a section of the reinforcement material spans the distance between the first and second gates.

14 The railcar assembly of any one of the clauses herein, wherein the railcar assembly is no more than 50 feet in length.

15. The railcar assembly of any one of the clauses herein, wherein each of the rigid side walls and rigid end walls has a height no greater than 4 feet.

16. The railcar assembly of any one of the clauses herein, wherein the container envelope is configured to transport granulated pig iron (GPI).

17 The railcar assembly of any one of the clauses herein, wherein the angled interior walls are angled based on an angle of repose of the GMUs, wherein the angle of repose is at least 35 degrees.

18. The railcar assembly of any one of the clauses herein, wherein the angled interior walls form an angle with the bottom surface of between 30-45 degrees.

19. A reinforced railcar container for receiving industrial product, the container comprising:
a floor comprising an impact pad configured to absorb the impact of industrial product dropped from a height, the impact pad positioned at an intermediate region along a length of the container, wherein the impact pad is an open-topped box containing a layer of granulated metallic units (GMUs);
rigid side walls extending from the floor, wherein the rigid side walls each have a first length and are approximately perpendicular to the floor; and
rigid end walls extending from the floor and between the rigid side walls, wherein the rigid end walls each have a second length less than the first length;
wherein top portions of the each of the rigid side walls and rigid end walls define an opening through which industrial product is deposited into the container.

20. The container of any one of the clauses herein, further comprising a reinforcement liner disposed over a portion of the floor and a portion of the rigid end walls.

21 The container of any one of the clauses herein, wherein the reinforcement liner is disposed over a portion of the rigid side walls.

22 The container of any one of the clauses herein, wherein the industrial product and the layer of GMUs includes GPI.

23 The container of any one of the clauses herein, wherein a first section of a reinforcement liner extends from approximately the top portion of a first rigid end wall and couples to the floor at a first angle, and a second section of the reinforcement liner extends from approximately the top portion of a second rigid end wall and couples to the floor at a second angle different than the first angle.

24. A method of loading granulated metallic units (GMUs) into a reinforced railcar assembly, the method comprising:
obtaining the railcar assembly, the railcar assembly including:
   a bottom surface,
   rigid side walls coupled to the bottom surface,
   rigid end walls coupled to the bottom surface and the rigid side walls, and
   angled interior walls (i) coupled to the bottom surface, rigid end walls, and/or rigid end walls, and (ii) angled relative to the rigid side walls and/or rigid end walls, wherein the bottom surface, rigid side walls, rigid end walls, and angled interior walls form a container envelope with an open top, and wherein the bottom surface and/or the angled interior walls comprise a reinforcement material; and
loading GMUs into the railcar assembly via the open top of the container envelope.

25. The method of any one of the clauses herein, wherein the container envelope further includes an open-topped box in contact with the bottom surface inside the container envelope, and the method further comprises filling the open-topped box with a layer of GMUs.

26. The method of any one of the clauses herein, wherein, the reinforcement material configured to extend the service life of the railcar assembly compared to conventional railcars, thereby reducing material waste

I/We claim:

1. A reinforced railcar assembly used for the transport of granulated metallic units (GMUs), the assembly comprising:
a container envelope comprising:
a bottom surface;
rigid side walls extending from the bottom surface, wherein the rigid side walls each have a first length and are approximately perpendicular to the bottom surface;
rigid end walls extending from the bottom surface and between the rigid side walls, wherein the rigid end walls have a second length less than the first length; and
angled interior walls, wherein each of the angled interior walls is coupled to the bottom surface, the rigid side walls, and one of the rigid end walls,
wherein top portions of each of the rigid side walls and rigid end walls define an opening of the container envelope configured to receive the GMUs; and
a reinforcement material disposed over a portion of the bottom surface and/or the angled interior walls.

2. The railcar assembly of claim 1, wherein the reinforcement material is a removeable liner from the container envelope.

3. The railcar assembly of claim 1, wherein the reinforcement material is coupled to the container envelope via one or more of: tack welding, bolting, fastening, clamping, clipping, and hanging to the container envelope.

4. The railcar assembly of claim 1, wherein the reinforcement material is comprised of one or more rigid plates.

5. The railcar assembly of claim 1, wherein the reinforcement material is comprised of one or more of: metal, metal alloy, metal cladding, refractory lining, and polyurethane.

6. The railcar assembly of claim 1, wherein the reinforcement material is further disposed over a portion of the rigid side walls.

7. The railcar assembly of claim 1, wherein the container envelope further includes an impact pad configured to absorb the impact of GMUs dropped from a height.

8. The railcar assembly of claim 7, wherein the impact pad is positioned at approximately a center point along the length of the container envelope.

9. The railcar assembly of claim 7, wherein the impact pad is an open-topped container containing a layer of GMUs.

10. The railcar assembly of claim 9, wherein the layer of GMUs is granulated pig iron (GPI).

11. The railcar assembly of claim 1, wherein the bottom surface includes a gate configured to discharge GMUs contained in the container envelope.

12. The railcar assembly of claim 11, wherein (i) the gate is a first gate, (ii) the bottom surface includes a second gate configured to discharge GMUs contained in the container envelope, and (iii) the first gate is a first distance in a first direction from a center point of the bottom surface and the second gate is a second distance in a second direction, opposite the first direction, from the center point of the bottom surface.

13. The railcar assembly of claim 12, wherein a section of the reinforcement material spans the distance between the first and second gates.

14. A reinforced railcar container for receiving industrial product, the container comprising:
a floor comprising an impact pad configured to absorb the impact of industrial product dropped from a height, the impact pad positioned at an intermediate region along a length of the container, wherein the impact pad is an open-topped box containing a layer of granulated metallic units (GMUs);
rigid side walls extending from the floor, wherein the rigid side walls each have a first length and are approximately perpendicular to the floor; and
rigid end walls extending from the floor and between the rigid side walls, wherein the rigid end walls each have a second length less than the first length;
wherein top portions of the each of the rigid side walls and rigid end walls define an opening through which industrial product is deposited into the container.

15. The container of claim 14, further comprising a reinforcement liner disposed over a portion of the floor and a portion of the rigid end walls.

16. The container of claim 15, wherein the reinforcement liner is disposed over a portion of the rigid side walls.

17. The container of claim 14, wherein the industrial product and the layer of GMUs includes GPI.

18. The container of claim 14, wherein a first section of a reinforcement liner extends from approximately the top portion of a first rigid end wall and couples to the floor at a first angle, and a second section of the reinforcement liner extends from approximately the top portion of a second rigid end wall and couples to the floor at a second angle different than the first angle.

19. A method of loading granulated metallic units (GMUs) into a reinforced railcar assembly, the method comprising:
obtaining the railcar assembly, the railcar assembly including:
a bottom surface,
rigid side walls coupled to the bottom surface,
rigid end walls coupled to the bottom surface and the rigid side walls, and
angled interior walls (i) coupled to the bottom surface, rigid end walls, and/or rigid end walls, and (ii) angled relative to the rigid side walls and/or rigid end walls, wherein the bottom surface, rigid side walls, rigid end walls, and angled interior walls form a container envelope with an open top, and wherein the bottom surface and/or the angled interior walls comprise a reinforcement material; and
loading GMUs into the railcar assembly via the open top of the container envelope.

20. The method of claim 19, wherein the container envelope further includes an open-topped box in contact with the bottom surface inside the container envelope, and the method further comprises filling the open-topped box with a layer of GMUs.
